(19) United States
(12) Patent Application Publication
(10) Pub. No.: US 2026/0277299 A1
(43) Pub. Date: Sep. 17, 2026

(54) SYSTEMS AND METHODS FOR OPTIMIZING ENERGY CONSUMPTION OF A DATACENTER

(71) Applicant: LOD Technologies Inc., Burnaby (CA)

(72) Inventor: Medi Naserimojarad, Vancouver (CA)

(21) Appl. No.: 19/568,181

(22) Filed: Mar. 16, 2026

Related U.S. Application Data
(60) Provisional application No. 63/772,697, filed on Mar. 16, 2025.

(51) Int. Cl. G06F 1/329; G06F 1/26

(52) U.S. Cl. CPC G06F 1/329; G06F 1/263

(57) ABSTRACT

A control system is provided for a datacenter. The control system includes a plurality of energy-consuming devices for performing critical and curtailable tasks, the control system configured to receive input data related to two or more energy sources for providing energy to the datacenter and one or more requests for performing critical tasks, determine a control strategy for optimizing a target parameter of the datacenter, and generate first command signals according to the control strategy. The first command signals are configured to switch between or mix the two or more energy sources in order to provide energy for the set of energy-consuming devices.

### TECHNICAL FIELD

The present disclosure generally relates to datacenter control systems and, more particularly, to power management in datacenters.

### BACKGROUND

Managing energy consumption in datacenters is a complex task with many factors in play. The main factors impacting energy consumption of a data center may include the source providing energy to the datacenter, the type(s) of loads in the datacenter, and the operational needs of the datacenter, such as optimizing sustainability or financial metrics.

The datacenter may source energy from a local power grid, a behind-the-meter (BTM) energy generating station, energy from energy storage devices, and/or a mix of these sources.

The type(s) of loads in a datacenter may generally include computing (e.g., data processing, data storage, AI model training, crypto currency mining) and non-computing loads (e.g., cooling systems, recharging batteries and uninterruptable power supply, generating clean energy carriers such as hydrogen).

Conventional methods to manage energy consumption of a datacenter include controlling power to energy consuming devices rather than controlling workload of the datacenter.

Accordingly, there is a need for improved systems and methods for optimizing energy consumption of a datacenter.

### SUMMARY

A control system for a datacenter is provided. The datacenter includes a plurality of energy-consuming devices for performing critical and curtailable tasks. The control system is configured to receive input data related to two or more energy sources for providing energy to the datacenter and one or more requests for performing critical tasks, determine a control strategy for optimizing a target parameter of the datacenter, and generate first command signals at least based on the control strategy. The first command signals are configured to control energy consumption of the datacenter by switching between or mixing the two or more energy sources and by modulating execution of tasks on the plurality of energy-consuming devices.

The plurality of energy-consuming devices may include a first plurality of devices for performing the critical tasks and a second plurality of devices for performing the curtailable tasks, and the control system may be further configured to generate second command signals to schedule the critical tasks to the first plurality of devices and to schedule the curtailable tasks to the second plurality of devices.

The critical tasks may be time sensitive, deferable, or a combination thereof.

The two or more energy sources may include at least a combination of an electrical grid, a Behind-The-Meter (BTM) energy source, and an energy storage system.

The energy storage system may include at least one of a battery system, a hydrogen-based energy storage system including a hydrogen fuel tank, a fuel cell system configured to generate electricity from stored hydrogen fuel, and an electrolyzer configured to consume energy from the grid and/or the BTM source to generate hydrogen fuel to modify the state of charge of the hydrogen fuel tank.

The energy storage system may be configured to directly provide energy to the plurality of energy-consuming devices, and the electrical grid or the BTM energy source may be configured to provide energy to the energy storage system to modify the state of charge of the energy storage system.

The target parameter may be selected from one or more of an energy consumption metric, a financial metric, and a sustainability metric.

The control strategy may be selected from one or more of minimizing datacenter costs, maximizing energy consumption of the datacenter or one or more energy sources, maximizing profits of the datacenter, minimizing environmental impacts of the datacenter, minimizing energy consumption of the datacenter during peak demands, providing ancillary services to support stability of the grid, maintaining the state of charge of the energy storage system within a certain threshold, and providing a predictable energy consumption on an energy source.

The input data may include one or more grid operation signals received from a grid operator or utility operator, the grid operation signals selected from of the group consisting of a demand response signal, a power curtailment signal, a power allocation signal, a grid frequency regulation signal, and a grid stability support signal. The control strategy may be determined based at least in part on the received grid operation signals.

The control system may receive further input data related to one or more of a demand workload strategy and datacenter operational requirements. The control strategy may be determined based on the demand workload strategy and/or the datacenter operational requirements.

The control system may further generate third command signals for one or more of the following: allocating power to the energy consuming devices, interacting with a grid operator, controlling energy generation at the BTM energy source, and controlling energy storage levels at the energy storage system.

The critical tasks may be time-sensitive, and the control system may generate fourth command signals to switch the energy source to prevent consuming energy from the electrical grid according to the control strategy to avoid high grid energy prices, avoid coincidental peaks from the grid energy, or respond to demand response signals from a grid operator.

The control strategy may be configured to provide a predictable energy consumption on the grid, and the control system may generate fifth command signals to schedule curtailable or deferable tasks to provide a predictable energy consumption profile on the electrical grid.

The control strategy may be configured to maximize profits of the datacenter, and the control system may send sixth command signals to the energy-consuming devices to schedule high-profit critical or curtailable tasks using energy sourced from BTM energy generation or by arbitraging energy stored in the energy storage systems.

The datacenter may include a plurality of datacenter facilities located at different geographic locations and connected to different grid interconnections, and the control system may be configured to coordinate energy consumption and workload scheduling across the plurality of datacenter facilities to optimize the target parameter of the datacenter or to respond to a grid operation signal.

A computer-implemented method for optimizing energy consumption of a datacenter is provided. The datacenter includes a plurality of energy-consuming devices configured to perform critical and curtailable tasks. The method includes receiving input data related to two or more energy sources supplying the datacenter and requests for performing critical tasks, determining, using a processor, a control strategy for optimizing a target parameter of the datacenter, and generating, using the processor, command signals based at least in part on the control strategy to control energy consumption of the datacenter by at least one of switching between or mixing the two or more energy sources, and controlling execution of tasks on the plurality of energy-consuming devices.

Controlling execution of the tasks may include modulating execution of one or more computing tasks or non-computing tasks by adjusting an execution timing, execution rate, duration, or intensity of the one or more computing tasks or non-computing tasks, including deferring execution of one or more deferable tasks and curtailing execution of one or more curtailable tasks.

Generating the command signals may further include scheduling execution of curtailable tasks or deferable tasks on one or more energy-consuming devices from the plurality of energy-consuming devices in order to adjust a power consumption profile of the datacenter over time to provide a predictable energy consumption profile on an energy source selected from the two or more energy sources.

Switching between or mixing the two or more energy sources may include controlling a power transfer switch to select, switch, or mix energy supplied from at least two of an electrical grid, a behind-the-meter energy source, and an energy storage system according to the control strategy.

Generating the command signals may further include modulating electrical power delivered to one or more of the energy-consuming devices.

According to a disclosed aspect herein, a control system is presented for a datacenter including a plurality of energy-consuming devices for performing critical and curtailable tasks. The critical tasks may be time-sensitive, deferable, or a combination thereof. The critical and curtailable tasks are computing tasks, non-computing tasks, or a combination thereof. The control system is configured to receive input data related to two or more energy sources, provide energy to the datacenter and provide one or more requests for performing critical tasks; determine a control strategy, the control strategy optimizing a target parameter; and generate command signals according to the control strategy. The commands signals are configured to switch between or mix the two or more energy sources in order to provide energy for the plurality of energy-consuming devices.

The energy-consuming devices of the datacenter may include a first plurality of devices for performing the critical tasks and a second plurality of devices for performing the curtailable tasks, and the control system may be further configured to generate command signals to schedule the critical tasks to the first plurality of devices and schedule the curtailable tasks to the second plurality of devices.

The two or more energy sources may include at least a combination of energy grid, Behind-The-Meter (BTM), and an energy storage system. The energy storage system may include a battery system, or a hydrogen fuel tank plus a fuel cell system configured to generate electricity by consuming hydrogen fuel. The energy from the grid, BTM, or a combination thereof may be consumed to generate hydrogen fuel to modify the state of charge of the hydrogen fuel tanks.

The two or more energy sources may include the energy storage system so that only the energy storage system is directly providing energy to the pluralities of energy-consuming devices of the datacenter while other energy sources in the two or more energy sources provide energy to the energy storage system to modify the state of charge of the energy storage system.

The target parameter may be selected from one or more of: an energy consumption metric (e.g., the amount of consumed energy); a financial metric (e.g., datacenter profit or energy costs); and a sustainability metric (e.g., amount of GHG emissions).

The control strategy may be selected from one or more of: minimizing datacenter costs; maximizing energy consumption of the datacenter or one or more energy sources; maximizing profits of the datacenter; minimizing environmental impacts of the datacenter; minimizing energy consumption of the datacenter during peak demands; providing ancillary services to support stability of the grid; maintaining the state of charge of the energy storage system within a certain threshold; and providing a predictable energy consumption on an energy source.

The control system may further be configured to receive input data related to one or more of: demand workload strategy; and datacenter operational requirements. The control strategy may be determined based on the demand workload strategy or the datacenter operational requirements, or a combination thereof.

The control system may further be configured to generate command signals for one or more of the following: allocating power to the energy consuming devices; interacting with a grid operator; controlling energy generation at a BTM energy source; and controlling energy storage levels at an energy storage source.

The critical tasks may be time-sensitive, and the control system may be configured to generate command signals to switch the energy source to prevent consuming energy from the grid according to the control strategy to avoid high-grid energy prices, avoid coincidental peaks from the grid energy, or respond to demand response signals from a grid operator.

The control strategy may be to provide a predictable energy consumption on the grid and the control system may be configured to generate command signals to schedule curtailable tasks to provide a predictable energy consumption profile on the grid.

The control strategy may be to maximize profits of the datacenter, and the control system may send command signals to the energy-consuming devices to schedule high-profit critical or curtailable tasks using energy sourced from BTM energy generation or by arbitraging energy stored in the energy storage systems. The control system may further be configured to send command signals to sell energy to the grid for a profit.

### BRIEF DESCRIPTION OF THE DRAWINGS

In the following, embodiments of the present disclosure will be described with reference to the appended drawings. However, various embodiments of the present disclosure are not limited to the arrangements shown in the drawings.

FIG. 1 is a schematic diagram of an energy consumption optimization system, according to one embodiment;

FIG. 2 is a schematic diagram of various workloads and energy-consuming devices in a datacenter;

FIG. 3 is a block diagram of a processor circuit for implementing the datacenter controller of the system of FIG. 1, according to an embodiment;

FIG. 4 is a series of energy consumption charts related to the datacenter of FIG. 1;

FIG. 5A is a further schematic diagram of the energy consumption optimization system, according to another embodiment;

FIG. 5B is a still further schematic diagram of the energy consumption optimization system, according to another embodiment; and

FIG. 6 is a flow diagram of a computer-implemented method for optimizing energy consumption of a datacenter, according to an embodiment.

### DETAILED DESCRIPTION

Provided are systems and methods for managing energy consumption (load) of a datacenter by managing workload to a heterogeneous and hybrid compute system. By managing workload commands to compute devices, the power consumption of the compute devices may advantageously be controlled in order to meet one or more specific operational needs of the datacenter, such as limiting power consumption.

Throughout this document, workload may refer to computing tasks and non-computing tasks. Computing tasks may include data processing (including but not limited to data ingestion, data cleaning, data transformation, data encryption, data decryption, data validation, data analysis, and data visualization), hosting, developing and training computing models (including but not limited to data models, simulation models, mathematical models, artificial intelligence models, neural network models, and large language models), tuning computing models, deploying and using computing models, parallel computing processes, running simulations such as Monte Carlo simulations, graphical simulations and rendering, audio processing and cryptocurrency mining processes. Non-computing tasks may include controlling cooling systems (e.g., Fans, HVAC systems) of a datacenter, charging backup power systems and batteries, generating electricity from energy generators and energy carriers (such as hydrogen) and operating electrolyzing devices to generate energy carriers such as hydrogen for later conversion to electricity.

The energy consumption patterns by various workload may vary depending on the nature of the workload. For example, time-sensitive computing workloads (e.g., a request to the datacenter to execute a computing model inference task) may be intermittent with irregular or unpredictable energy-consumption loads. For some application-specific integrated circuits (ASICs) (such as ASICs for cryptocurrency miners) the workloads tend to be consistent and predictable, resulting in consistent and predictable energy consumption patterns, while charging backup power systems and hydrogen fuel generations may be intermittent, unpredictable, and on-demand.

Computing power refers to the capability to perform or conduct computation or executing a computing task.

Computing models or computational models may refer to data, simulation, physics, mathematical, neural network, protein folding, and/or forecasting models that use computer programs and data to simulate and study complex systems using mathematics, physics, and computer science. A computing model includes numerous variables that characterize the system being studied.

Throughout this application, “datacenter” may refer to a large network of computing servers and computing devices configured for execution of computing tasks such as storage, processing, and distribution of data. A datacenter may also include non-computing devices such as cooling devices, power distribution units (PDUs), uninterruptible power supply (UPS), electricity generators (e.g., fuel cells), energy storage systems (e.g., battery systems or fuel tanks), and electrolyzer devices, among other non-computing devices. Throughout this application, “datacenter” may also refer to a single computing server or computing device of a datacenter. Throughout this application, “datacenter” may also refer to one or more batches of computing servers or computing devices of a datacenter. The datacenter may further include application-specific integrated circuits (ASIC) configured to perform specialty workloads such as cryptocurrency mining and running specialty computational models (e.g., Groq™, Smaba Nova™, Cerebras™, DMatrix™, AI ASICs specialized to run large language models (LLMs)).

A device product refers to a primary product generated by a device and is the aim of operating the device. The amount of the device product is measured by a product signal. For example, the device product of a cryptocurrency miner is the hash rate or hashing power that is priced by a hash price and is sold in exchange for the cryptocurrency it mines (e.g., Bitcoin). In a further example, the device product of a GPU is computational processing carried out by the GPU and is measured by various metrics depending on the type of computational process (e.g. the number of tokens or generated outputs by a large language model). In a still further example, the device product of a hydrogen electrolysis device is the amount of produced hydrogen measured in metric tonnes or per unit time. In a still further example, the device product of an actuator is the amount of power or work generated by the actuator and measured by kilowatts or kilojoules, respectively. In a still further example, the device product of a reactor is the volume or mass of primary material processed at the output of the reactor. In the foregoing examples, the product signal respectively includes the amount of cryptocurrency mined, the number of generated outputs by the large language model (e.g. number of tokens), the metric tonnes of hydrogen produced, the kilowatts or kilojoules produced by the actuator, and the processed volume or mass from the reactor. In some cases, the product signal may also include the monetary value associated with these product signals. In other cases, this monetary value of the product signal is indicated by a product price signal. The costs associated with producing the products may be indicated by a product production cost signal. The difference between the product price signal and the product production cost signal may be indicated by a product profit margin signal. A breakeven energy price signal may indicate an energy price (e.g. in $ per MW·hr) below which it makes economic sense to consume energy to produce the device product. A breakeven efficiency signal may indicate the amount of energy consumed per device product produced at which it is determined to produce the device product (e.g., according to economics or economic sense, viz., whether it will be profitable to produce the device product according to the energy consumed at a specific energy price). For example, the breakeven efficiency of a cryptocurrency miner may be measured by joule per terahash, which is the amount of energy consumed to compute one terahash.

Compliance obligations may refer to both contractual agreements, such as energy agreements defined and exemplified hereinbelow, and government or industry regulations, such as data privacy and environment, social, governance (ESG) regulations.

Load shaping refers to deliberate management and adjustment of the power consumption profile of a datacenter over time. Datacenters may, for example, use load shaping to reduce peak power demands, take advantage of low energy prices or avoid times of high prices, enhance energy efficiency, and potentially participate in demand response programs and ancillary services related to a power grid. In various embodiments described herein, load shaping may be achieved by controlling one or more of: (i) execution and scheduling of workloads on energy-consuming devices, (ii) selection, mixing, or switching among multiple available energy sources supplying the datacenter, and (iii) modulating power delivered to energy-consuming devices, including activation (turning on), deactivation (turning off), or throttling of devices.

In some embodiments described herein, controlling execution and scheduling of workload refers to modulating execution of computing and non-computing tasks, including deferring, advancing, pausing, resuming, or changing an execution rate or intensity of tasks, thereby indirectly changing power consumption of energy-consuming devices. In contrast, modulating power delivered to energy-consuming devices refers to electrical-side control of power input to the devices, including turning devices on or off, changing device power states, and/or controlling delivered electrical characteristics such as voltage, current, frequency, power factor, or duty cycle, independently of whether task execution is modified.

Sending or commissioning instructions or commands or command signals to a datacenter may refer to sending instructions to a controller of the datacenter, a computing server in the datacenter, and/or a computing device (e.g. graphics processing unit (GPU), central processing unit (CPU), application-specific integrated circuit (ASIC) device, cryptocurrency mining device) of the datacenter. The instructions or commands may include high-level strategies (e.g., follow a power consumption target directive, prioritize environmental impacts over cost savings), may include detailed tasks (e.g., shut down all or a certain percentage of computing devices, adjusting computing hardware resources dedicated to a certain computing task, or specific computing task such as training an AI model or allocating workload to cryptocurrency mining devices), or may be a combination thereof.

The environmental impact may include environmental impacts related to sourcing energy and electricity, such as greenhouse gas emissions produced by fossil fuel generators. The energy sourcing impacts may be related to all types of energy sources including power grid, behind the meter sources, and backup power sources. The environmental impacts may further include computing impacts that are environmental impacts that are caused due to operating or performing computational processes in a datacenter, such as greenhouse gas emissions from cooling refrigerants in the datacenters or excessive heat generated by the computing devices.

Although “energy” and “power” have distinct technical definitions, in the context of this description, these terms may have been used interchangeably when referring to general energy consumption or supply, except in cases where “power” specifically pertains to computational capacity or processing capability. For example, “energy consumption targets” can mean “power consumption targets” and vice versa.

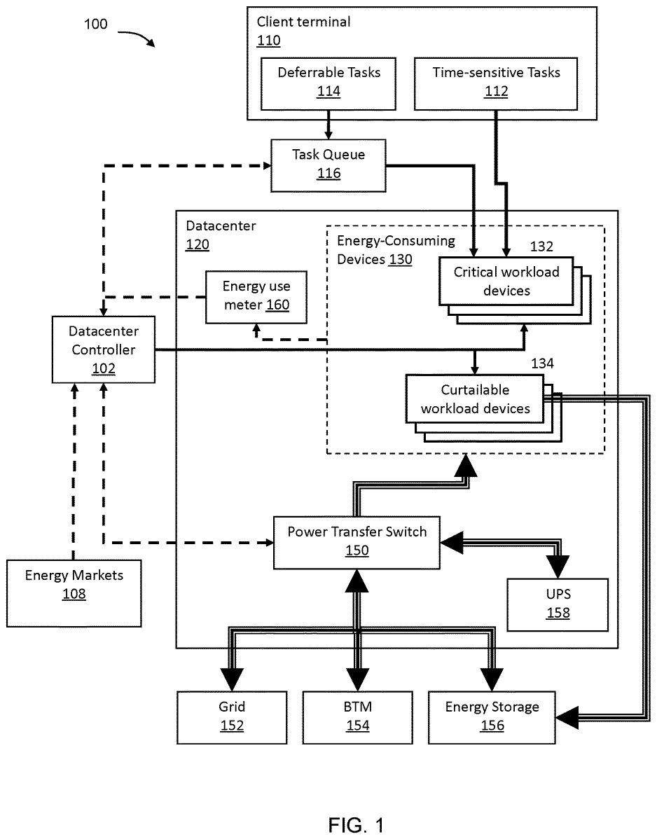

Referring to FIG. 1, a schematic diagram of a system for energy consumption optimization of a datacenter 120 is generally shown at 100, according to an embodiment. In FIG. 1, compound lines show transmission of power, solid lines show transmission of workload including computing and non-computing workloads, and dashed lines show flow of measurement or commands signals, such as measurement data related to energy use and energy markets.

The system 100 uses a datacenter controller 102 to monitor various types of input data and control energy consumption of the datacenter 120. The datacenter controller 102 may be implemented by a computer server or a node in a cloud computing environment or may be implemented by a local computer remote or within the premises of the datacenter 120.

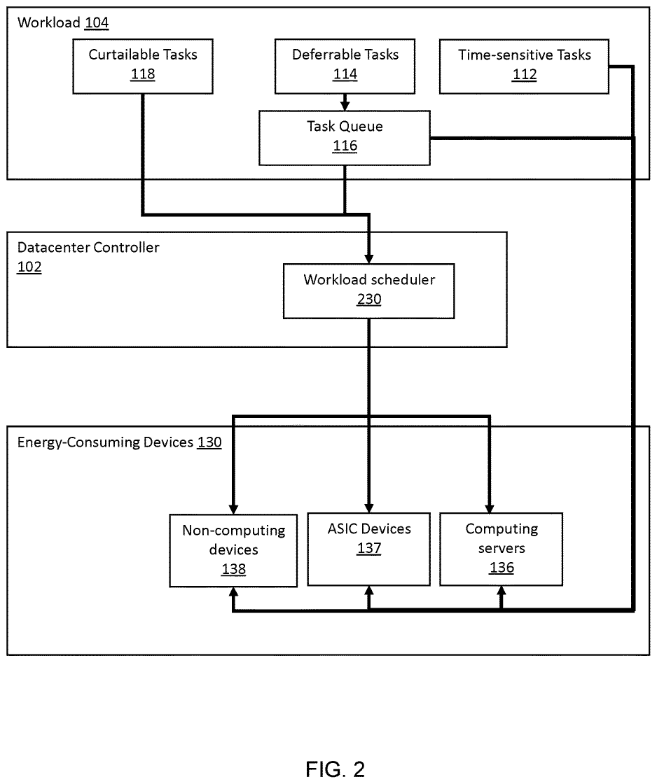

The datacenter 120 comprises energy-consuming devices 130 such as computing devices and servers 136 (shown in FIG. 2) configured to execute computing tasks, application-specific integrated circuit (ASIC) devices 137 (shown in FIG. 2) configured to operate application-specific devices such as cryptocurrency miners, and non-computing devices 138 (shown in FIG. 2) such as cooling devices, energy carrier-producing devices (such as electrolysis devices to produce hydrogen fuel), and energy storing devices (such as UPS and batteries). The computing servers 136 may comprise hardware such as memories, data storage units, and processors including CPU, GPU, field-programmable gate array (FPGA), and cloud computers. The computing servers 136 may include a single server of processors, a cluster of servers, multiple servers controlled by a central controlling server, or multiple slave servers supporting a master server, among other configurations of the computing servers. The computing servers 136 are configured to perform various computing tasks or computational processes.

The non-computing devices 138 may include cooling devices and network and communication devices. The datacenter 120 may also include energy storage devices such as UPS, batteries, and fuel tanks (such as hydrogen fuel tanks). In some cases, the datacenter 120 may also include further non-computing devices 138 such as electrolysis devices that consume energy to produce energy carriers such as hydrogen fuel and other products such as purified valuable metals and materials. The produced energy carriers may be used to generate electricity, for example in peak times of electricity demand or at times when using energy from the power grid is not economical or optimal otherwise.

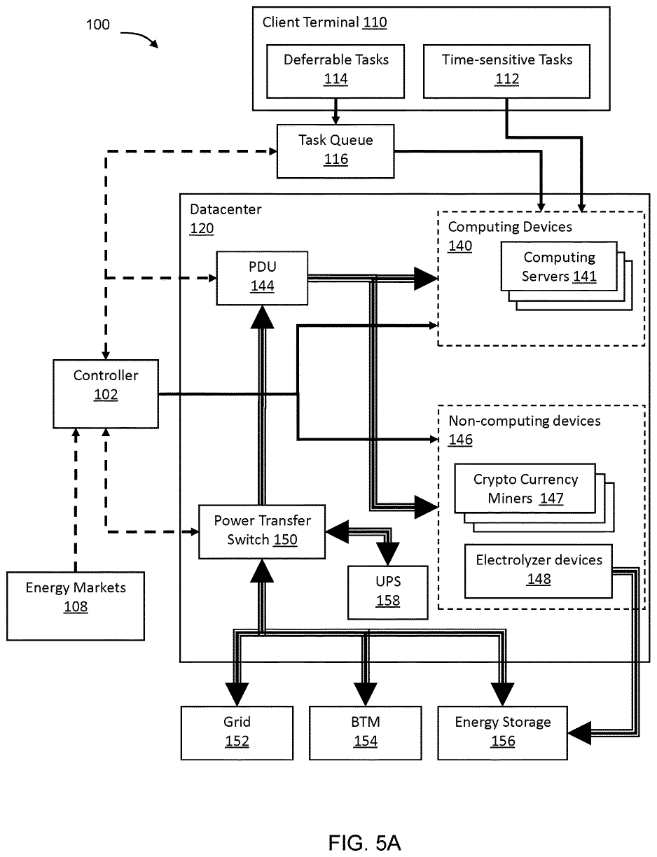

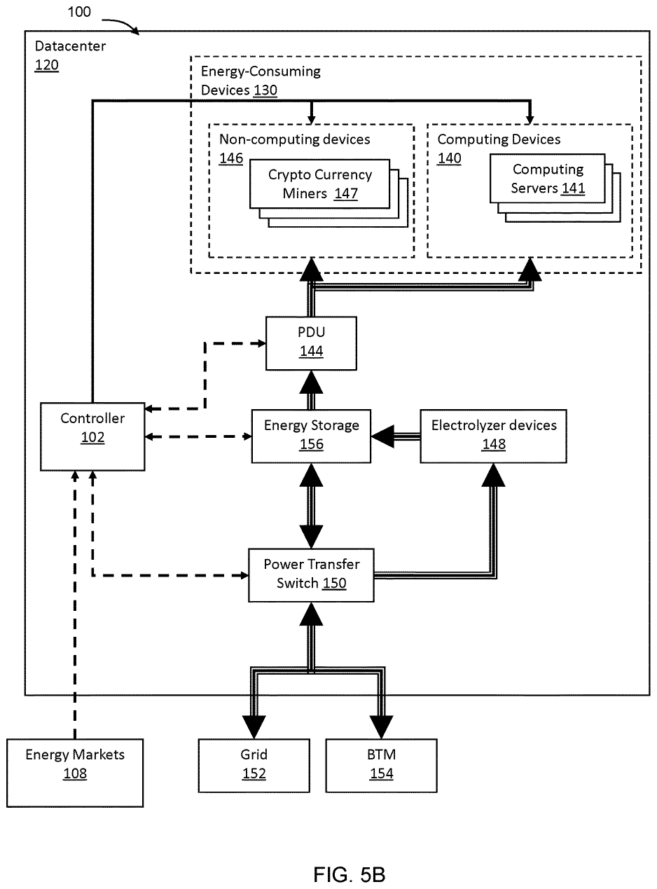

Electrical energy for energy-consuming devices 130 may be supplied to the datacenter 120 from various sources including power grid 152, a behind-the-meter or BTM source 154 such as a solar, fuel cells, or wind farm, and an energy storage system 156 such as a battery, flywheels, fuel tanks, or power banks which include backup batteries that store energy for times when energy from primary energy sources (e.g., the power grid 152) is interrupted. In some cases (e.g., in the embodiment shown in FIG. 5B), the energy provided from the energy storage system 156 may be the primary energy source in a datacenter 120 for directly providing energy to the energy-consuming devices 130. These energy sources may be located outside of the datacenter 120 as shown in FIG. 1. Alternatively, the BTM 154, the energy storage systems 156, or a combination of both may be located on premises of the datacenter 120. In some embodiments, the grid 152, BTM supply 154, and energy storage system 156 collectively form a hybrid energy architecture or microgrid associated with the datacenter 120, in which the controller 102 manages energy flow among the energy sources and the datacenter loads to achieve the desired operational objectives.

Sourcing energy from the BTM 154 renewable energy sources, such as on-site solar and wind installations, in combination with energy storage systems 156, may significantly reduce greenhouse gas (GHG) emissions associated with datacenter operations. By relying on locally generated renewable energy rather than grid power, which may be sourced from fossil fuels, the datacenter 120 may cut down on the carbon footprint associated with its energy consumption. In an embodiment, the energy storage systems 156 further enhance this capability by storing excess renewable energy generated during periods of high production (e.g., midday solar peaks) and discharging that energy during periods of low renewable generation or peak grid demand, ensuring continuous reliance on clean energy without interruption.

In many cases, two or more of these various energy sources are used to ensure energy stability, redundancy, and reliability for the datacenter. The supplied energy from these various sources is transmitted to a power transfer switch 150. The power transfer switch 150 is configured to transmit one or a mix of the sourced energy to the energy-consuming devices 130. The power transfer switch 150 is further configured to mix or switch among energy sources (e.g., between the grid 152 and a BTM 154). According to one embodiment, the switch 150 receives information about the state and various parameters (e.g., active and reactive power, cost, stability, frequency, ripples, harmonic distortions) of the energy sources and determines a mixing strategy of the energy sources for further transmission to the energy-consuming devices 130. Alternatively, the switch 150 may receive a command signal from the datacenter controller 102 to implement a mixing strategy calculated and determined by the controller 102. The mixing strategy, whether calculated by the controller 102 or the power transfer switch 150, may be a fixed or static strategy that does not change over time or may be an adaptive or dynamic strategy that changes over time. The mixing strategy may be a rule-based strategy or may be AI-based (e.g., using machine learning or reinforcement learning). The mixing strategy may include an amount or a percentage of each of the energy sources. For example, the mixing strategy may be to source the datacenter energy entirely from the grid 152 (100% grid+0% BTM+0% energy storage), or may be an event-based mixing strategy to source up to 20% from the BTM 154 and 10% from the energy storage 156 if the energy cost from the grid 152 goes beyond a threshold, or if the overall energy consumption in the datacenter 120 goes beyond a threshold, or if the frequency in the grid 152 decreases below or increases above a certain threshold. According to an example, if the main energy source (e.g., the grid 152) becomes unstable, the transfer switch 150 is configured to signal the secondary source (e.g., the BTM 154) to startup and source power from a combination of the grid 152 and the BTM 154, until the grid 152 power source returns to normal. An uninterruptible power supply (UPS) 158 within the premises of the datacenter 120 may also provide power to the energy-consuming devices 130 through the power transfer switch 150 for further redundancy and reliability of energy sources. In some embodiments, the UPS 158 may be considered a component of, or an implementation of, the energy storage system 156, such that the energy storage system 156 includes one or more UPS 158 devices and associated backup batteries configured to store electrical energy and discharge the stored energy to supply power to the energy-consuming devices 130 via the power transfer switch 150. Accordingly, references herein to the energy storage system 156 may include embodiments in which the energy storage system 156 comprises or includes the UPS 158, and command signals directed to controlling the energy storage system 156 may include commands for charging, discharging, and/or configuring power delivery from the UPS 158.

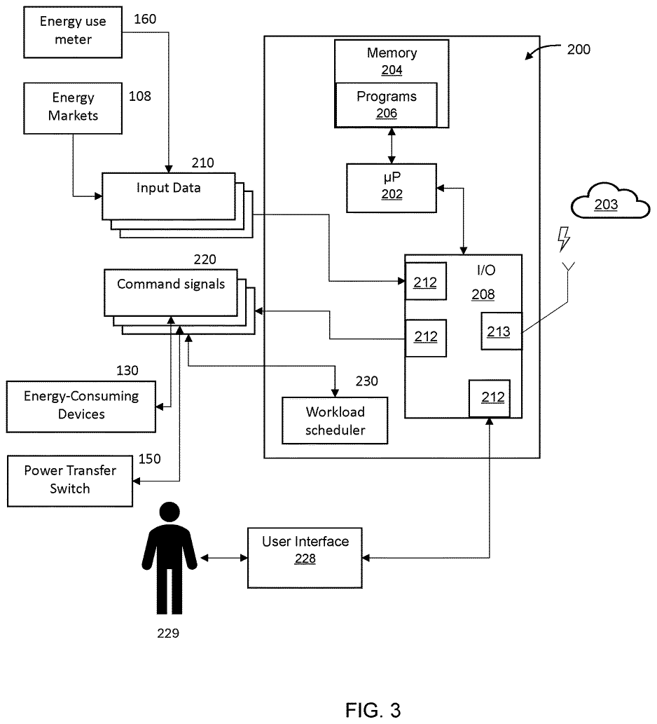

The power transfer switch 150 may be one or more mechanical or solid-state breakers or one or more digitally-controlled power converters such as inverters or buck and boost converters that are configured to enable or disable flow of power from one or multiple energy sources or mixing energy from different energy sources. The power transfer switch 150 may be or may include an automatic transfer switch (ATS) configured to automatically switch power between the various sources of energy to provide uninterrupted power supply to the datacenter 120. The datacenter controller 102 may receive input data 210 (shown in FIG. 3) related to energy sources, for example, from the power transfer switch 150, monitor the energy sources data, and send command signals 220 (shown in FIG. 3) to the power transfer switch 150 to mix and switch among one or more of the energy sources. The input data 210 related to the energy sources may include the type of energy sources (e.g. the energy grid 152, the behind the meter 154, or the energy storage devices 156), their voltage, current, rated power or energy capacity, frequency, price, availability, and any other information associated with the sourced energy (e.g., the provider, and regulatory or compliance information).

Referring to FIG. 5A, another embodiment of the energy consumption optimization system 100 is shown. In the embodiment shown in FIG. 5A, instances of computing devices 140 are presented as computing servers 141 which are configured to perform critical computing tasks 112 and 114. Additionally, instances of non-computing devices 146 are presented as cryptocurrency miners 147 and electrolyzer devices 148. A PDU 144 is used as an intermediary between regulated energy from the power transfer switch 150 and the energy consuming devices 140 and 146. Furthermore, UPS 158 may be used as an additional source of energy which is configured to draw from and inject power to the power transfer switch 150.

Referring to FIG. 5B, another embodiment of the energy consumption optimization system 100 is shown. In the embodiment shown in FIG. 5B, the energy storage system 156 is the primary energy provider for the energy-consuming devices 130 and directly provides energy to the energy-consuming devices 130. Energy storage systems 156 usually store and provide energy in direct current (DC) form and in some cases may be the preferred energy source for providing energy to energy-consuming devices that consume DC energy. The power transfer switch 150 routes energy from the grid 152 and the BTM 154 to the energy storage system 156 to modify the state of charge of the energy storage system 156 (e.g., the state of charge of the batteries). The power transfer switch 150 may include converters to convert energy from the grid 152 and the BTM 154 sources (or any other energy sources) to the energy form used by the energy storage system 156. Additionally, the power transfer switch 150 may include inverters to convert the energy stored in the energy storage system 156 back to the form used by the power grid 152, in cases where the datacenter 120 is configured to provide energy to the grid 152 (e.g., to monetize excess energy in the datacenter, to support stability of the grid 152 due to grid obligations, or grid ancillary services).

In some embodiments, the energy storage system 156 includes a hydrogen fuel tank configured to store hydrogen fuel and a hydrogen fuel cell configured to generate electricity by consuming hydrogen fuel. In such cases, energy from the grid 152, the BTM 154, or any other energy source, or a combination thereof, may be consumed by the electrolyzer devices 148 to generate hydrogen fuel to modify the state of charge of the hydrogen fuel tanks. The hydrogen fuel in fuel tanks is mainly used as a green and clean energy carrier, which may be used for electricity production at grid 152 peak times or high grid energy prices.

Data or information signals related to the state of charge of the energy storage system 156 may be communicated with the controller 102. The controller 102 may determine a suitable control strategy to modify the state of charge of the energy storage system 156. For example, if the energy storage levels in the energy storage system 156 fall below a certain threshold, the controller 102 may send command signals to the power transfer switch 150, or any other energy-sourcing device, to provide energy to charge the energy levels in the energy storage system 156. Alternatively, in some embodiments, if the energy levels in the energy storage system 156 are above a certain threshold or if it is economical, the controller 102 may determine to sell an excess amount of the energy stored in the energy storage system 156 for a profit.

Accordingly, the energy stored in the energy storage system 156 may be used to arbitrage energy to make profits or reduce costs for the datacenter 120. In other words, the controller 102 may adopt a profit making or cost reduction strategy by buying, storing, or consuming energy at the energy storage system 156 when prices are low and selling, discharging, or reducing energy consumption at the energy storage system 156 when prices are high, to take advantage of price fluctuations in the grid 152 or in the BTM 154 and effectively profiting from the difference in energy prices over time.

The datacenter controller 102 may be a local controller within or proximate to the premises of the datacenter 120 or may be a remote controller, for example implemented in a cloud computer. An implementation of the datacenter controller 102 is shown at 200 in FIG. 3, according to one embodiment.

In some embodiments, the control system 100 may control energy consumption across a plurality of datacenter facilities or energy-consuming installations located at different geographic locations. Each facility may include one or more datacenters (i.e., one or more instances of datacenter 120), compute clusters, or other energy-consuming devices that are connected to different electrical grid interconnections and associated with separate energy meters. The datacenter controller 102 may aggregate the controllable loads across these geographically distributed facilities and manage them as a coordinated portfolio of energy-consuming assets. For example, the controller 102 may coordinate a first datacenter located in a first grid region operating cryptocurrency mining devices with a second datacenter located in another grid region operating AI training servers. The controller 102 may determine a global control strategy that schedules workloads and energy sourcing across the plurality of facilities in order to satisfy an aggregated energy consumption target, participate in grid demand response programs, or fulfill grid operator dispatch instructions.

In some embodiments, the aggregated controllable load across multiple datacenters may be treated as a single dispatchable energy resource from the perspective of the controller 102. The controller 102 may receive grid operation signals specifying a power consumption target or load reduction amount and may distribute the desired load adjustments across the plurality of datacenters based on local energy prices, workload flexibility, availability of curtailable tasks, and availability of behind-the-meter energy resources. Accordingly, geographically distributed compute assets may collectively respond to grid signals as an aggregated flexible load resource.

The grid 152 may be understood as an electric utility or a power company in the electric power industry that engages in electricity generation and distribution of electricity for sale generally in a regulated market. The grid 152 may further include grid regulators or operators such as ERCOT, CAISO, and NYISO in the United States of America or AESO and IESO in Canada. It should be understood that the grid 150 may further include or refer to an operator of the energy grid, an energy generation station, or a local control station.

In an embodiment, the grid 152 refers to an electrical power grid comprising one or more power generation facilities and associated infrastructure for generating, transmitting, distributing, and supplying electrical energy. The grid 152 may include one or more physical components such as power stations, renewable energy generation facilities, transmission lines, substations, distribution networks, and grid interconnection infrastructure through which electrical energy is delivered to the datacenter 120. The grid 152 may further include systems and entities responsible for operating and regulating the electrical network, such as independent system operators (ISOs), regional transmission organizations (RTOs), or utility operators, which manage the dispatch, pricing, and reliability of electricity supplied through the grid.

The behind-the-meter (BTM) supply 154 includes energy or power from a power generation system, such as, but not restricted to, a wind or solar power system, where energy sourcing occurs before the generated electricity undergoes a step-up transformation to convert it into high-voltage AC power for transmission to the grid 152. Thus, the BTM supply 154 may include electricity directly sourced from an intermittent power generation system, such as a wind farm or solar array, rather than relying on the main grid 152. The BTM supply 154 may be remote to the datacenter 120 or may be co-located and within the premises of the datacenter 120.

The datacenter 120 may have an energy agreement with one or more authorities managing the grid 152, the BTM supply 154, the energy storage 156 supply, or any other external service providers administering energy sourcing to the datacenter 120. The energy agreement may include power blocks purchased from the grid 152, a power purchase agreement (PPA) between the datacenter 120 and the BTM 154 or the energy storage 156 supply, a virtual PPA (VPPA), an energy hedge agreement with a non-energy grid counterparty to manage the financial risk in energy cost fluctuations, or incentive program agreements such as ancillary services and demand response program agreements, introduced by energy grid authorities, for example, to support frequency regulation, voltage regulation and balancing supply and demand in the grid 152 network.

Moreover, the energy agreement may include programs that allow the datacenter 120 to flow excess energy generated from a co-located BTM supply 154 or power storage 156 to the grid 152 for a benefit such as monetary incentives.

Through any of these energy agreements, the datacenter 120 may be incentivized or have the option to stop consuming energy, to sell back energy to the grid 152, to sell excess energy to the grid 152, to sell the option to purchase or use energy to the grid 152 or another interested entity, to cut energy consumption during certain time periods, or to commit to consume certain amounts of energy in certain times. A skilled person in the art may be familiar with various types of energy agreements that may exist between a grid 152 and a datacenter 120.

The energy agreement may be an energy option agreement, i.e., an agreement between the grid 152 and the datacenter 120 associated with the delivery of energy to the datacenter 120. As part of a power option agreement, the datacenter 120 (or an operator for the datacenter 120, a contracting agent for the datacenter 120, or a semi-automated or automated control system associated with the datacenter 120—such as the datacenter controller 102) provides the grid 120 with the right, but not obligation, to reduce the amount of energy delivered to the datacenter 120 up to an agreed amount of energy during an agreed upon time interval. In order to provide the grid 152 with this option, the datacenter 120 is contractually committed to be using at least the amount of energy subjected to the option (e.g., a minimum energy threshold). For instance, the datacenter 120 may agree to use at least 1 MW of energy from the energy grid 152 at all times during a specified 24-hour time interval to provide the grid 152 with the option of being able to reduce the amount of energy delivered to the datacenter 120 by any amount up to 1 MW at any point during the specified 24-hour time interval. The datacenter 120 may grant the grid 152 this option in exchange for a monetary consideration such as receiving energy at a reduced price and/or monetary payments if the option is exercised by the grid 152.

The power option agreement may provide a sequence of minimum energy limits over different periods of time. The power option agreement may provide maximum power consumption targets that the datacenter 120 is committed to stay below.

The above-mentioned energy agreements may be information communicated to the datacenter controller 102 through energy markets 108 and may play a key role in determining a workload strategy and the decision-making of the datacenter 120 on when and how to consume energy to maximize profits for the datacenter 120, for example by reducing the energy cost of the energy-consuming devices 130 as well as maximizing execution of a workload (as shown at 104 in FIG. 2) by critical workload devices 132 and curtailable workload devices 134. The energy agreements may be leveraged in manual decision-making by a manager of the datacenter 120. In a preferred embodiment, methods are provided to streamline and automate the decision-making by a computer process, for example implemented in the datacenter controller 102. The energy agreements may be loaded on the datacenter controller 102.

The datacenter controller 102 is further configured to receive input data related to the measured consumed energy in the datacenter 120 from an energy use meter 160, for example. The energy use meter 160 is connected to the energy-consuming devices 130 and is configured to frequently measure and provide data such as amount of consumed energy, frequency, voltage, and current related to the energy-consuming devices 130. The controller 102 is further configured to receive input data related to the state of charge of the energy storage system 156 (e.g., the state of charge of the batteries, hydrogen fuel tanks, or both).

The energy-consuming devices 130 may be categorized into a first plurality of devices configured to execute critical workloads (the critical workload devices 132), and a second plurality of devices configured to execute curtailable workloads (the curtailable workload devices 134).

The critical workloads include critical computing tasks and critical non-computing tasks that are to be executed by a deadline. The critical workloads may include time-sensitive tasks 112 which are intended for immediate execution, and deferable tasks 114 which may potentially be deferred or delayed to a later time. Deferrable tasks 114 are usually provided with a deadline for completing the task and as the deadline approaches sufficiently, the deferrable task may be considered a time-sensitive task 112. Critical workloads may include computing tasks, such as data analysis, data storage, model training, and model inference that are sent to the datacenter 120 for execution by the computing servers. Critical workloads may include non-computing tasks, such as achieving a state of charge for the energy storage system 156 (e.g., certain battery charge levels or hydrogen fuel tank levels) within a deadline. The critical computing workloads may be sent to the datacenter 120 by a client terminal 110 or any other computer that receives demanded tasks from a client or user. Time-sensitive tasks 112 are sent directly and immediately to the datacenter 120 and to the critical workload devices 132 for execution. For example, a DNS routing module, a content distribution network (CDN), a DNS management module, a global traffic manager (GTM), or load balancer may be used by a processor connected to the client terminal 110 to immediately route the time-sensitive tasks 112 to the critical workload devices 132. Deferable tasks 114 may be queued in a task queue module 116 and be sent for execution to the datacenters 120 and the critical workload devices 132 at an appropriate time. The used DNS routing module or the GTM may choose across multiple datacenters and eventually route the tasks to the most suitable datacenter.

Examples of the time-sensitive tasks 112 include mission critical banking or health data that require real time processing. Such critical workload requires high-performance computing (HPC) which is often time-, speed-, and interrupt-sensitive (i.e., to be executed without delay and without interruption). The time-sensitive tasks 112 may further include critical workloads that are time- and interrupt sensitive but that have a certain flexibility to the speed of execution. Examples of such time-sensitive tasks include computing tasks on AI training processes which can be throttled up and down but cannot be paused or stopped, as progress would be lost. Time-sensitive tasks 112 may further include short and intermittent tasks such as inference of AI models (i.e. AI model inference), where execution of the task is desired immediately. AI model inference tasks are usually time-sensitive because these tasks are usually demanded with an expectation of immediate results. However, in certain cases, where the task results are not desired immediately, such AI model inference tasks may be considered deferrable tasks 114.

The curtailable tasks 118 include curtailable computing tasks and/or curtailable non-computing tasks whose executions are flexible, not critical, and often optional. Execution rate, timing, or duration of the curtailable tasks 118 may be reduced, delayed, paused, or interrupted without materially impacting crucial functionality, obligations, or requests from the datacenter 120. The curtailable tasks 118 may include interruptible and demand-independent (i.e. workload is available on demand) computing tasks, such as performing large data analytics processes, and computing tasks that may be paused, such as weather modeling or non-critical AI model trainings where usually tasks take a longer amount of time (e.g., several weeks) to be processed and completed. Further examples of curtailable tasks 118 include mining cryptocurrency, storing energy for later use, and generating energy carriers (e.g., generating hydrogen fuel from electrolysis) for later energy generation. As shown in FIG. 1, energy may be consumed at the curtailable workload devices 134 to generate energy and supply energy back to the energy storage systems 156. For this purpose, energy from the grid 152 and/or the BTM 154 may be consumed, particularly during times when energy costs from these sources are low-cost and economical, to store these low-cost energies in the energy storage systems 156. This low-cost energy may be used by the datacenter 120 during times with higher prices in the grid 152 or the BTM 154.

The workload on specialty hardware and ASICs, such as cryptocurrency mining and running specialty computational models (e.g., Groq™, Smaba Nova™, Cerebras™, DMatrix™) may be critical (i.e., time-sensitive or deferable) and/or curtailable depending on the nature of each task commissioned to these hardware.

When a workload is received at the client terminal 110, a time sensitivity of the task may be associated with the task. For example, a client may select whether the workload is time-sensitive or deferrable. Alternatively, the client may select whether the task is time-sensitive or not, or indicate a level of time sensitivity to the workload. In some embodiments, the determination of a workload being time-sensitive or deferable may be done automatically by a processor (which may be the datacenter controller's microprocessor 202 shown in FIG. 3 or a similar microprocessor) connected to the client terminal 110. For example, the processor may be configured to identify certain task types as time-sensitive while labeling others as deferrable or curtailable tasks based on a pre-defined rule (e.g., processing and data storage tasks are time-sensitive, model training tasks are deferable, and cryptocurrency tasks are curtailable). The processor may then determine the optimum route for the workload according to the selected or determined time sensitivity. Time-sensitive tasks 112 can be routed to the datacenter 120 immediately through a DNS routing service, for example, while deferrable tasks may be queued in the task queue 116. The tasks queued in the task queue 116 may be routed to the DNS routing service depending on the type of the task and a task execution strategy calculated and communicated by the datacenter controller 102.

Referring to FIG. 2, a flow diagram related to flow of various workload 104 or tasks are presented, according to one embodiment. In the embodiment shown in FIG. 2, time-sensitive tasks 112 are directly communicated to the energy-consuming devices 130 for execution. Deferable tasks 114 are communicated to the task queue 116. Tasks in the task queue 116 are either directly communicated to the energy-consuming device 130 for execution or are passed on to the datacenter controller 102 for further scheduling. In some embodiments, the time-sensitive and deferable tasks 112 and 114 not only include computing tasks received from the client terminal 110, but also time-sensitive and deferable tasks related to the operations of the datacenter 120 such as operating cooling devices (which may be very time-sensitive at times) and maintaining the operations of datacenter devices such as the PDU 144 (which may be time-sensitive or deferable at times). Curtailable tasks 118 are communicated to the datacenter controller 102 to be scheduled, by the datacenter controller 102, for execution by the energy-consuming device 130. The datacenter controller 102 includes a workload scheduler 230 configured to receive tasks from the task queue 116 as well as curtailable tasks 118 and schedule the deferable tasks 114 queued in the task queue 116 and the curtailable workloads 118 for execution based on the control strategy of the datacenter 120, operational requirements of the datacenter 120, and a priority assigned to each task. Deferable workloads 114 are typically mission-critical, resource-intensive tasks for which high reliability and stability are desirable, such as model training, data analysis, or scientific simulations. In contrast, curtailable workloads 118 such as cryptocurrency mining (e.g., from ASIC-based mining rigs) are less time-sensitive and may be throttled or shifted without significant impact on operations of the workload. In an embodiment, scheduling a workload 104 includes dynamically throttling, scaling, pausing, resuming, or adjusting the computational intensity of a task executing on one or more energy-consuming devices 130 in order to modulate the power consumption of the datacenter 120.

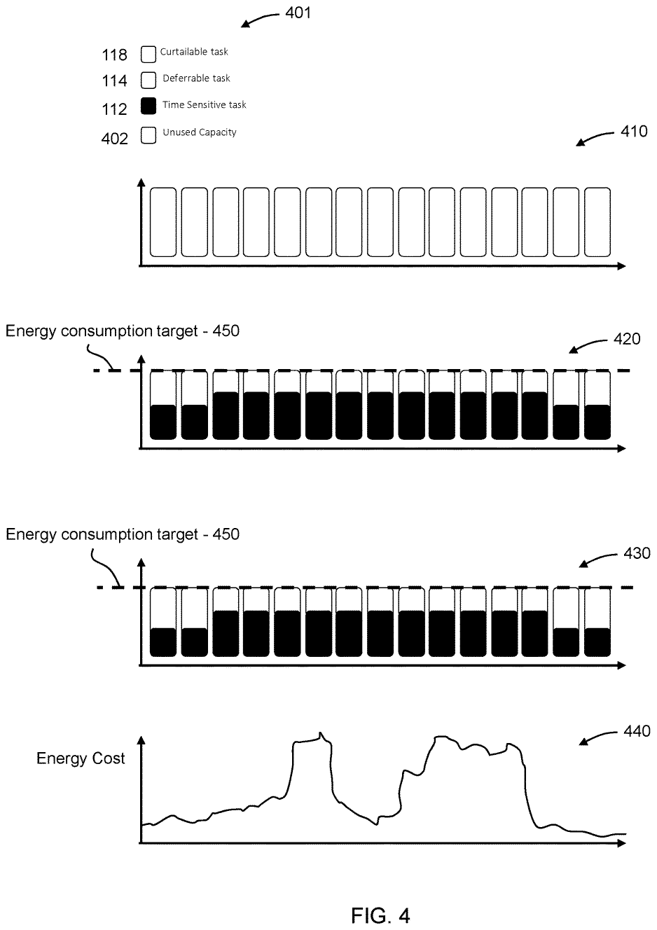

Accordingly, the datacenter controller 102 is further configured to adaptively and dynamically manage and balance critical and curtailable workloads. In a preferred embodiment, critical workloads are given priority for execution on the critical workload devices 132; however, if the amount of energy consumption by critical workloads devices 132 is lower than an energy consumption target 450 (as shown in FIG. 4), the controller 102 is configured to schedule execution of curtailable workloads 118 on the curtailable workload devices 134. In other words, the controller 102 is configured to fill-in energy consumption valleys and unused capacities 402 (as shown in FIG. 4) by scheduling and commanding execution of curtailable loads in the datacenter 120. This functionality optimizes energy usage, costs (e.g., by preventing penalties resulting from lack of energy consumption agreed upon in the energy agreements), and workload distribution, enabling efficient datacenter operation by adapting to changes in energy availability, cost, and workload demand in real-time.

Referring to FIG. 3, a schematic diagram of a processor circuit 200 for implementing the datacenter controller 102 is shown, according to an embodiment. Accordingly, the processor circuit 200 is variously referred to as a datacenter controller 200 herein. The datacenter controller 200 may be implemented using an embedded processor circuit such as a Linux-operated computer. The datacenter controller 200 includes a microprocessor 202, a memory 204, and an input output (I/O) module 208, all of which are in communication with the microprocessor 202. The I/O 208 includes one or more wireless interfaces 213 (such as an IEEE 802.11 interface) for wirelessly receiving and transmitting data communication signals between the datacenter controller 200 and other controllers, input and output devices (e.g., wireless sensors, wireless power switches, wireless network switches, wireless gateways) or a cloud server 203 through a wireless network. The I/O 208 further includes a plurality of wired network interfaces 212 (such as an Ethernet™, USB, and controller area network (CAN) interfaces) for connecting to and receiving input data 210 from datacenter devices or devices external to the datacenter (e.g., devices related to the power grid or energy markets). The wired network interfaces 212 may further connect to and communicate data (send and receive) from a user interface 228 which is configured to receive further input data 210 from a user 229.

The input data 210 may include input data and data received from an energy use meter 160, the power transfer switch 150, the energy markets 108 (including energy agreements), the workload 104, the tasks queue 116, and the user interface 228. In some embodiments, all or a portion of the energy-consuming devices 130 further provide input data for the datacenter controller 200 regarding various information such as the operational status of the devices (e.g., on, off, on standby, hibernated, over clocked, under clocked), log of tasks or workload performed by the devices, and maintenance and diagnostic logs (e.g., errors, predictive maintenance notifications). In some embodiments, the input data 210 further includes data communications from the PDU 144 (shown in FIGS. 5A and 5B) to communicate information about the state of the PDU 144 and the powered devices. In some embodiments, the input data 210 is received at the controller 200 through the wireless interface 213 (e.g., input data from the cloud server 203) or through a user interface 228 (e.g., input data from a user 229).

The input data 210 further includes data communications from the workload 104 which include information regarding critical tasks (deferable tasks 114 and time-sensitive tasks 112) and curtailable tasks 118 that are requested or demanded to be executed in the datacenter 120. In some embodiments, the workload 104 is associated with a demand workload strategy (not shown in Figures), which may correspond to one or more of the critical and curtailable tasks and generally indicates the factors, constraints, and conditions (e.g., optimal energy consumption, or limited CO2 emissions) under which the workload is preferred or requested to be performed. The demand workload strategy may be determined by the entity or actor that demands the workload 104. According to one embodiment, the demand workload strategy is determined by a client through the client terminal 110. The workload 104 and the associated demand workloads strategy may be received as input data to the controller 200.

Different types of workload 104 (e.g. curtailable, deferable, and time-sensitive) may be associated with a single shared demand workload strategy or multiple distinct demand workload strategies.

The wired network interfaces 212 further connect to and communicate command signals 220 with various datacenter devices, such as energy-consuming devices 130 and power transfer switch 150, as well as workload scheduler 230. The command signals 220 are generated by the processor 202 as a result of programs 206 executed on the processor 202. The generated command signals 220 are communicated through the I/O 208. The commands signals 220 control the energy consumption in the datacenter by controlling the flow of energy, the amount of energy, the energy source, and more generally the characteristics of the energy (e.g., including voltage, frequency, current, timing), and also by modulating the workload or tasks commissioned to the energy-consuming devices 130. The command signals 220 include commands communicated to the workload scheduler 230, the energy use meter 160, the power transfer switch 150, and the energy-consuming devices 130. The command signals 220 include commands for switching or mixing energy source among two or more energy sources (i.e., at the power transfer switch 150); schedule critical computing tasks to the first plurality of devices (i.e., using the task queue 116); and schedule curtailable computing tasks on the second plurality of devices.

In some embodiments, the microprocessor 202 (or the workload scheduler 230 under control of the microprocessor 202) evaluates multiple scheduling parameters when determining when and where to execute tasks within the datacenter 120. Such parameters may include energy price signals, availability of energy from the grid 152, the BTM source 154, or the energy storage system 156, current and predicted energy consumption levels of the datacenter 120, device availability and performance characteristics, workload deadlines, task priority levels, and profitability or efficiency metrics associated with executing particular workloads. Based on these parameters and the selected control strategy, the microprocessor 202 may generate command signals 220 for the workload scheduler 230 to assign workloads to specific energy-consuming devices 130, delay execution of deferable workloads 114, throttle execution rates of certain tasks, or activate or deactivate curtailable workload devices 134 in order to maintain a desired energy consumption profile of the datacenter 120.

The command signals 220 may also be generated to regulate total harmonic distortions (THD), active versus reactive power, voltage, and frequency of the electrical energy consumed by the energy-consuming devices 130 in the datacenter 120. The commands signal 220 may also be generated to control voltage for DC-based power sourcing and management in the datacenter 120. The controller 102 may actively manage voltage in DC power sourcing, for example, by dynamically adjusting the workload on the energy-consuming devices 130 and sourced energy mix through the power transfer switch 150. The controller 102 may generate command signals for THD management based on the input data 210 and real-time measurements from the energy use meter 160, measurements from the power transfer switch 150, and overall datacenter operating conditions. Parameters such as DC voltage ripple, switching noise, and transient distortions may be monitored by the controller 102 through the input data 210 to determine, generate, and commission the suitable command signals 220. The generated command signals 220 may be commissioned to various components involved in power conversion and distribution such as the PDU 144 and DC-DC converters and inverters (not shown in Figures) to mitigate harmonic distortion and regulate DC power for sensitive computing loads. Managing THC is particularly crucial in datacenters where DC power sources such as energy storage systems 156, hydrogen fuel cells, and photovoltaic (PV) arrays are used to ensure reliable and stable power delivery to computing loads.

The controller 200 is further configured to determine a control strategy, in part based on the received input data 210. The control strategy may be determined by using instructions provided in the programs 206. For example, the instruction in the programs, when executed by the microprocessor 202, may determine the control strategy by selecting from a list of predetermined or predefined control strategies, or by calculating a control strategy using a rule-based method or using an artificial intelligence method. In particular, in an embodiment, the control strategy is determined by executing one or more optimization algorithms configured to evaluate multiple operational parameters simultaneously, including energy price signals, workload characteristics, energy availability from different energy sources, contractual obligations, and operational constraints of the datacenter 120. The optimization algorithms may include rule-based optimization, linear or nonlinear optimization, stochastic optimization, and/or machine learning-based decision models configured to dynamically determine an energy sourcing and workload scheduling strategy. Alternatively, the control strategy may be instructed, by the user 229, to the controller 200. The control strategy may include one or more of the following strategies: minimizing datacenter costs; maximizing energy consumption of the datacenter 120; maximizing profits of the datacenter 120; minimizing environmental impacts of the datacenter 120; minimizing energy consumption of the datacenter 120 during peak demands; providing ancillary services to support stability of the grid 152; maintaining the state of charge of the energy storage system 156 within a certain threshold; and providing a predictable energy consumption on an energy source. The control strategy may be configured to optimize a target parameter that is critical for the datacenter 120 or its operation. The target parameter may be determined by the selected control strategy and can include one or more of the following parameters: an energy consumption metric (e.g., amount of consumed energy); a financial metric (datacenter profit, energy cost); and a sustainability metric (e.g., amount of direct or indirect GHG emissions resulted from operating the datacenter 120, amount of water or refrigerant consumed for the cooling systems in the datacenter 120, amount of heat generated due to operating the datacenter 120). In some embodiments, one or more target parameters are selected or determined initially (by the user 229 or by the instructions provided in the programs 206) and a control strategy is calculated at the microprocessor 202 according to the determined target parameters.

In some embodiments where the controller 102 is configured to control a plurality of datacenter facilities or energy-consuming installations located at different geographic locations, the target parameter optimized by the control strategy may be an aggregated target parameter defined with respect to the plurality of facilities as a coordinated portfolio, rather than being defined solely for a single datacenter or facility. The aggregated target parameter may be determined as a portfolio-level objective computed from a plurality of facility-level parameters measured at respective sites, including parameters derived from separate energy meters, local grid interconnections, local energy price signals, local emissions or carbon-intensity signals, and local operational constraints. For example, the aggregated target parameter may include an aggregate power consumption profile (e.g., total megawatt draw across the plurality of facilities as a function of time), an aggregate energy consumption budget over a time window (e.g., total megawatt-hours consumed across sites), an aggregate curtailment response obligation (e.g., total megawatt reduction across sites in response to a grid operation signal), an aggregate financial objective (e.g., minimizing total energy cost or maximizing total profit across sites), or an aggregate sustainability objective (e.g., minimizing total greenhouse gas emissions across sites subject to one or more constraints). In such embodiments, the controller 102 may determine the control strategy to optimize the aggregated target parameter by distributing, across the plurality of facilities, decisions related to workload scheduling and execution (including deferring deferable tasks and curtailing curtailable tasks), energy-source selection, mixing, or switching, and any other load shaping actions described herein, while optionally satisfying additional site-specific constraints associated with individual facilities, such as interconnection limits, energy agreements, service-level objectives, or reliability requirements.

In further embodiments, even when the controller 102 is configured to control a plurality of datacenters, the target parameter optimized by the control strategy may be defined on a per-facility basis rather than as an aggregated target parameter, such that the controller 102 determines one or more respective control strategies for optimizing respective target parameters for each datacenter facility independently, for example where each datacenter facility is subject to different energy agreements, different grid constraints, different service-level objectives, or different optimization priorities, and the controller 102 may coordinate control actions across the plurality of datacenters while maintaining compliance with the respective target parameters applicable to each facility.

The control strategy may be stored in the memory 204, may be generated by the programs 206 (e.g., using rule-based or machine learning based strategy generation algorithms), may be an input provided by the user 229 through the user interface 228, or may be provided by the cloud server 103. The control strategies may be guided by inputs received from the user interface 228 or determined automatically or semi-automatically by programs 206 executed by the microprocessor 202, or a combination of both. The programs 206 are embodied or stored in one or more non-transitory computer-readable storage media in the memory 204. The programs 206 include various instructions, such as rule-based algorithms or machine-learning-based algorithms, which when executed by the microprocessor 202, instruct the microprocessor 202 to process the received input data 210 and generate and/or commission suitable command signals 220 (e.g., sending commands to the energy-consuming devices 130, the power transfer switch 150, and the PDU 144, scheduling workloads).

The command signals 220 are commissioned to various devices in the datacenter 120 to implement the determined control strategy and thus to control the energy consumption in the datacenter 120.

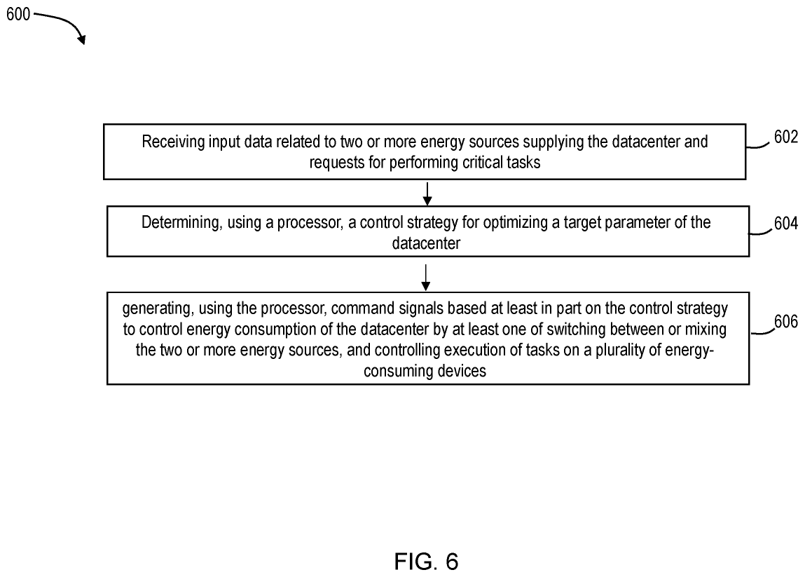

Referring now to FIG. 6, a computer-implemented method for controlling energy consumption of the datacenter 120 is shown generally at 600, according to an embodiment. The process 600 may be performed by the datacenter controller 102 and, in particular, by the processor circuit 200.

At 602, the method 600 comprises receiving input data related to two or more energy sources supplying the datacenter and receiving requests for performing critical tasks. The two or more energy sources may include the electrical grid, a behind-the-meter energy source, and/or an energy storage system.

At 604, the method 600 further comprises determining, using a processor, a control strategy for optimizing a target parameter of the datacenter. The target parameter may be an energy consumption metric, a financial metric, or a sustainability metric of the datacenter. The control strategy may further incorporate constraints and/or operational requirements such as energy agreements or grid operational signals.

At 606, the method 600 further comprises generating, using the processor, command signals based at least in part on the determined control strategy to control energy consumption of the datacenter by at least one of switching between or mixing the two or more energy sources, and controlling execution of tasks on a plurality of energy-consuming devices.

Controlling the energy consumption may include generating command signals 220 to the power transfer switch 150 to switch between or mix energy supplied from the grid 152, the BTM source 154, the energy storage system 156, and/or the UPS 158, and further generating command signals 220 to the workload scheduler 230 to control execution of tasks on the plurality of energy-consuming devices 130, for example by scheduling, deferring, throttling, pausing, resuming, or curtailing execution of deferable tasks and/or curtailable tasks to achieve a desired energy consumption profile. In some embodiments, the method 600 (including the elements 602, 604, and 606) is implemented as computer-executable instructions forming one of the programs 206 stored in the memory 204, and the method 600 is executed by the microprocessor 202 to generate and commission the command signals 202 described herein.

Referring back to FIG. 3, the user interface 228 may include a graphical user interface configured to display information to the user 229 and receive the input data 210 from the user 229. In some embodiments, the user interface 228 includes a textual or application programming interface (API) based user interface. The user 229 may be one or more operators or managers of the datacenter 120 or the datacenter controller 200. The user 229 may receive information from the controller 200 regarding the input data 210, the command signals 220, the workload scheduler 230, or in general the operations of the datacenter 120 including the amount of energy consumed, the cost of operating the datacenter 120 and the energy-consuming devices 130, the energy consumption targets or mandates of the datacenter 120, and control strategies of the datacenter 120. The user 229 may further provide input data, such as target energy consumption levels (e.g. 10 MWh in a specific time window), control strategies (e.g. when to use the curtailable workload devices 134, strategies to reduce overall costs on the datacenter 120) adopted by the controller 200, and configuration data related to the energy-consuming devices 130 (e.g. how to respond to device errors, when to maintain the energy-consuming devices 130), to the controller 200.

The programs 206 are embodied or stored in one or more non-transitory computer-readable storage media.

In some embodiments, the datacenter controller 102 may receive grid operation signals from a grid operator, utility operator, independent system operator (ISO), or regional transmission organization (RTO). These grid operation signals may include demand response signals, power curtailment requests, power allocation directives, frequency regulation requests, or other grid stability support signals. Such signals may be received through the wired network interfaces 212 or wireless interfaces 213 and incorporated into the input data 210 used by the controller 102. The controller 102 may determine a control strategy responsive to the received grid operation signals by modifying energy sourcing, scheduling curtailable workloads, throttling energy-consuming devices 130, or otherwise adjusting the energy consumption profile of the datacenter 120.

Referring to FIG. 4, a series of energy consumption charts 410, 420, and 430 illustrate various energy consumption profiles based on three different scenarios as explained herein. For all three charts, the adopted control strategy is to maximize profits resulting from the execution of the tasks. In all scenarios, it is assumed that performing a task produces an economic value. Chart 440 indicates the energy price over time corresponding to all three charts 410, 420, and 430. The presented charts 410, 420, and 430 distinguish between three main types of the workload 104 of the datacenter 120, namely time-sensitive tasks 112, deferable tasks 114, and the curtailable tasks 118, as shown in a legend 401 of the charts. Unused capacity 402 of the datacenter is also identified in the charts. Each chart indicates energy consumption levels (e.g., indicated by megawatts of energy consumption) at the vertical axis, and time at the horizontal axis. Each bar in each chart indicates energy consumption at a given time window (e.g., one hour, one day, one week). The first chart 410 illustrates the energy consumption profile for a scenario where energy consumption is only due to execution of curtailable tasks 118. Energy usage is curtailed at times when the energy price is high (executing curtailable tasks is not economical or cost effective). Otherwise energy is consumed to perform the curtailable tasks 118.

The second chart 420 illustrates the energy consumption profile for a scenario for executing critical tasks in the datacenter 120. An energy consumption target 450 (e.g., a maximum energy consumption target allocated to the datacenter 120 according to an energy agreement) is shown by a dashed line. Time-sensitive tasks 112 are executed at all times regardless of the energy cost due to the sensitivity of the tasks. Deferable tasks 114 are only executed when energy prices are low (since it is economical to perform the tasks) and only to a level to ensure the datacenter 120 energy consumption does not exceed the target 450. Otherwise, the deferable tasks 114 are queued in the task queue 116 and are released for execution when the energy cost is low.

The third chart 430 illustrates the energy consumption profile for a scenario where critical and curtailable tasks are scheduled for execution. In this scenario, the controller 102 implements the control strategy to schedule various task types to generate the highest profits. In this scenario, time-sensitive tasks 112 are executed without any control from the controller 102; time-sensitive tasks are executed at all times regardless of the energy price. However, the controller 102 has determined to execute deferable tasks 114 at times with the lowest energy price (since deferable tasks are critical and while their execution may be postponed, it is highly desirable to execute them) and execute the curtailable tasks 118 when the energy price is medium. In other words, the controller 102 decides to schedule value-generating curtailable tasks when energy prices are reasonable to fill in the unused energy capacity (i.e., valley filling) of the datacenter 120 by automatically scheduling curtailable tasks at time windows when the energy price is medium. When scheduling the deferable tasks 114 and the curtailable tasks 118, the controller 102 ensures that energy consumption levels do not exceed the target 450 threshold. This workload scheduling ensures the highest economic returns for the datacenter 120 while respecting the energy agreements (to avoid penalties) and the critical nature of time-sensitive and deferable tasks.

### EXAMPLES

Provided herein are examples to provide further details and embodiments related to the presented specifications.

### Example 1: Energy Cost Minimization

In a scenario where the datacenter 120 is sourcing energy from the grid 152, the controller 102 may determine, according to a control strategy selected to minimize an energy cost metric, to curtail or reduce curtailable workloads 118 during peak grid pricing periods, directing available power to execute the critical workloads 112 and 114 only. In such embodiments, the controller 102 receives an energy price signal from the energy markets 108 as part of the input data 210 and, based on the control strategy, generates command signals 220 to the workload scheduler 230 to delay, throttle, pause, or otherwise curtail scheduling of curtailable tasks 118 on curtailable workload devices 134 during the peak pricing periods. When prices drop, execution of the curtailable workloads 118 by the curtailable workload devices 134 may be increased, for example by the controller 102 generating additional command signals 220 to the workload scheduler 230 to increase an execution rate or duty cycle of curtailable tasks 118, while allowing the critical workload devices 132 to continue operation uninterrupted while reducing operational costs.

In some examples, the foregoing generation and commissioning of command signals 220 to the workload scheduler 230 to delay, throttle, pause, or otherwise curtail execution of the curtailable tasks 118 (and/or to prioritize execution of the critical workloads 112 and 114) may be performed not only in response to peak grid pricing periods, but also in response to other input data 210, including one or more grid operation signals received from a grid operator or utility operator, such as demand response signals or power curtailment signals, whereby the controller 102 determines, according to the control strategy, a corresponding load adjustment and generates the command signals 220 to implement the load adjustment.

### Example 2: Energy Cost Optimization

In a scenario where the grid energy price is high or grid demand is high or there is a demand response program called by the grid 152, the controller 102 sends command signals 220 to the power transfer switch 150 to switch energy source from the grid 152 to the BTM 154 or the energy storage systems 156. This switching is determined by the controller 102 due to a cost optimization control strategy and given sourcing energy from the BTM 154 and the energy storage systems 156 is more cost effective or financially more profitable while considering the incentives offered by the grid 152. Reducing or eliminating sourcing energy from the grid 152 may also provide compliance to the contractual requirements of the energy agreements which may further avoid penalties and reduce costs on the datacenter 120.

### Example 3: Maximize Renewable Energy Usage and Minimizing Ghg Emissions

In a scenario, where the datacenter 120 is receiving excessive energy sourced from renewable BTM energy sources (e.g., solar or wind are generating excess energy), the controller 102 may add this renewable energy to the mix of energy provided to the datacenter 120 (e.g. by sending commands to the power transfer switch 150 to add the renewable BTM source to the energy mix) or commission execution of curtailable workloads 118 to consume this surplus energy. This usage of excessive renewable energy not only reduces GHG emissions (e.g., by drawing less energy from high-GHG emitting energy production such as fossil fuel generators) but further allows the curtailable workloads devices 134 to operate at a higher (and potentially full) capacity without drawing expensive energy sourced from the grid 152. The GHG emissions may be the target parameter, and minimizing the GHG emissions may be the control strategy carried out by the controller 102.

### Example 4: Load Consistency and Predictability for Grid

For scenarios where a stable load on the grid 152 is highly desirable (which may be instructed by the energy agreements, for example), the controller 102 may allocate more load to the curtailable workloads 118 when demand for the critical loads 112 and 114 drops, thereby ensuring a consistent power draw from the grid 152. This functionality of the controller 102 helps stabilize grid interactions and may enable the datacenter 120 to participate in demand response programs or receive incentives for predictable energy use.

### Example 5: Maximizing Energy Use From Energy Storage Systems

In some scenarios, energy sourced from the energy storage systems 156 (e.g., batteries) may be mixed with energy sourced from the grid 152 or the BTM 154 to reduce energy ripples from the grid 152 and BTM 154 sources. In such scenarios, the controller 102 may monitor ripples and frequencies in the sourced energies and if the ripples are determined to be harmful for the energy-consuming devices 130 or in such a manner as to interrupt the execution of the workloads 104 (particularly the time-sensitive tasks 112), send command signals to the power transfer switch 150 to kick in energy from reliable and stable energy sourced from the energy storage systems 156.

In similar examples, to reduce energy costs and maximize profits, during times that the grid energy costs are low, the controller 102 sends command signals to curtailable workload devices 134 that are responsible for energy storage (e.g. recharging batteries or hydrogen electrolysis to produce hydrogen fuel) to store energy and increase the state of charge in the energy storage system 156. Later, at times when the grid energy cost is high or demand response signals are received from the grid 152, the controller 102 sends command signals to the power transfer switch 150 to stop or minimize drawing power from the grid 152 and instead source power from the energy storage systems 156 (e.g. batteries or fuel cells) to execute the workloads 104. This energy arbitrage may serve the cost minimization and profit maximization control strategies.

In some examples, consuming DC electrical power is preferred over AC power and thus the controller 102 may be configured to send command signals to direct all grid energy to charge the energy storage systems 156 while commanding all the workload devices (particularly computing devices and servers) to be powered entirely by the DC power sourced from the energy storage systems 156.

The advantages of the present disclosure include but are not limited to:
optimal use of compute and non-compute resources in a datacenter facility while maintaining consistent energy consumption; balancing loads between critical and curtailable workloads by dynamically prioritizing based on real-time energy availability, cost, and the datacenter's workload demands, ensuring optimal use of available resources while maintaining consistent energy consumption;
consistent energy consumption profile on power grid, by adjusting load between critical and curtailable workloads, may prevent sudden dips or peaks in power draw, which stabilizes the power grid;
by selecting workloads with higher profit margins and by increasing grid incentives and reducing grid penalties related to grid ancillary services, profits for the datacenter may be maximized.
ability to automatically scale or throttle computational resources in critical and curtailable workloads based on the real-time status of energy sources, which may optimize performance while minimizing costs for the datacenter.

While specific embodiments have been described and illustrated, such embodiments should be considered illustrative only and not as limiting the disclosed embodiments as construed in accordance with the accompanying claims.

1. A control system for a datacenter, the datacenter comprising a plurality of energy-consuming devices for performing critical and curtailable tasks, the control system configured to:
receive input data related to two or more energy sources for providing energy to the datacenter and one or more requests for performing critical tasks;
determine a control strategy for optimizing a target parameter of the datacenter;
and generate first command signals at least based on the control strategy, wherein the first command signals are configured to control energy consumption of the datacenter by switching between or mixing the two or more energy sources and by modulating execution of tasks on the plurality of energy-consuming devices.

2. The control system of claim 1, wherein the plurality of energy-consuming devices comprise a first plurality of devices for performing the critical tasks and a second plurality of devices for performing the curtailable tasks, and wherein the control system is further configured to generate second command signals to schedule the critical tasks to the first plurality of devices and to schedule the curtailable tasks to the second plurality of devices.

3. The control system of claim 1, wherein the critical tasks are time sensitive, deferable, or a combination thereof.

4. The control system of claim 1, wherein the two or more energy sources include at least a combination of an electrical grid, a Behind-The-Meter (BTM) energy source, and an energy storage system.

5. The control system of claim 4, wherein the energy storage system comprises at least one of a battery system, a hydrogen-based energy storage system including a hydrogen fuel tank, a fuel cell system configured to generate electricity from stored hydrogen fuel, and an electrolyzer configured to consume energy from the grid and/or the BTM source to generate hydrogen fuel to modify the state of charge of the hydrogen fuel tank.

6. The control system of claim 5, wherein the energy storage system is configured to directly provide energy to the plurality of energy-consuming devices, and the electrical grid or the BTM energy source is configured to provide energy to the energy storage system to modify the state of charge of the energy storage system.

7. The control system of claim 1, wherein the target parameter is selected from one or more of:
an energy consumption metric;
a financial metric; and
a sustainability metric.

8. The control system of claim 1, wherein the control strategy is selected from one or more of:
minimizing datacenter costs;
maximizing energy consumption of the datacenter or one or more energy sources;
maximizing profits of the datacenter;
minimizing environmental impacts of the datacenter;
minimizing energy consumption of the datacenter during peak demands;
providing ancillary services to support stability of the grid;
maintaining the state of charge of the energy storage system within a certain threshold; and
providing a predictable energy consumption on an energy source.

9. The control system of claim 1, wherein the input data comprises one or more grid operation signals received from a grid operator or utility operator, the grid operation signals selected from of the group consisting of:
a demand response signal;
a power curtailment signal;
a power allocation signal;
a grid frequency regulation signal; and
a grid stability support signal;
wherein the control strategy is determined based at least in part on the received grid operation signals.

10. The control system of claim 1, wherein the control system receives further input data related to one or more of:
a demand workload strategy; and
datacenter operational requirements;
wherein the control strategy is determined based on the demand workload strategy and/or the datacenter operational requirements.

11. The control system of claim 1, wherein the control system further generates third command signals for one or more of the following:
allocating power to the energy consuming devices;
interacting with a grid operator;
controlling energy generation at the BTM energy source; and
controlling energy storage levels at the energy storage system.

12. The control system of claim 1, wherein the critical tasks are time-sensitive, and wherein the control system generates fourth command signals to switch the energy source to prevent consuming energy from the electrical grid according to the control strategy to avoid high grid energy prices, avoid coincidental peaks from the grid energy, or respond to demand response signals from a grid operator.

13. The control system of claim 1, wherein the control strategy is configured to provide a predictable energy consumption on the grid, and wherein the control system generates fifth command signals to schedule curtailable or deferable tasks to provide a predictable energy consumption profile on the electrical grid.

14. The control system of claim 1, wherein the control strategy is configured to maximize profits of the datacenter, and wherein the control system sends sixth command signals to the energy-consuming devices to schedule high-profit critical or curtailable tasks using energy sourced from BTM energy generation or by arbitraging energy stored in the energy storage systems.

15. The control system of claim 1, wherein the datacenter comprises a plurality of datacenter facilities located at different geographic locations and connected to different grid interconnections, and wherein the control system is configured to coordinate energy consumption and workload scheduling across the plurality of datacenter facilities to optimize the target parameter of the datacenter or to respond to a grid operation signal.

16. A computer-implemented method for optimizing energy consumption of a datacenter, the datacenter comprising a plurality of energy-consuming devices configured to perform critical and curtailable tasks, the method comprising:
receiving input data related to two or more energy sources supplying the datacenter and requests for performing critical tasks;
determining, using a processor, a control strategy for optimizing a target parameter of the datacenter; and
generating, using the processor, command signals based at least in part on the control strategy to control energy consumption of the datacenter by at least one of:
switching between or mixing the two or more energy sources; and
controlling execution of tasks on the plurality of energy-consuming devices.

17. The method of claim 16, wherein controlling execution of the tasks comprises modulating execution of one or more computing tasks or non-computing tasks by adjusting an execution timing, execution rate, duration, or intensity of the one or more computing tasks or non-computing tasks, including deferring execution of one or more deferable tasks and curtailing execution of one or more curtailable tasks.

18. The method of claim 16, wherein generating the command signals further comprises scheduling execution of curtailable tasks or deferable tasks on one or more energy-consuming devices from the plurality of energy-consuming devices in order to adjust a power consumption profile of the datacenter over time to provide a predictable energy consumption profile on an energy source selected from the two or more energy sources.

19. The method of claim 16, wherein switching between or mixing the two or more energy sources comprises controlling a power transfer switch to select, switch, or mix energy supplied from at least two of an electrical grid, a behind-the-meter energy source, and an energy storage system according to the control strategy.

20. The method of claim 16, wherein generating the command signals further comprises modulating electrical power delivered to one or more of the energy-consuming devices.
